(19) United States
(12) Patent Application Publication
(10) Pub. No.: US 2013/0261254 A1
(43) Pub. Date: Oct. 3, 2013

(54) REACTIVE DILUENTS, METHODS OF REACTING, AND THERMOSET POLYMERS DERIVED THEREFROM

(71) Applicant: SEGETIS, INC., Golden Valley, MN (US)

(72) Inventors: Brian D. Mullen, Delano, MN (US); Marc D. Rodwogin, Minneapolis, MN (US); Dorie J. Yontz, Bloomington, MN (US)

(73) Assignee: SEGETIS, Inc., Golden Valley, MN (US)

(21) Appl. No.: 13/852,024

(22) Filed: Mar. 28, 2013

Related U.S. Application Data
(60) Provisional application No. 61/618,559, filed on Mar. 30, 2012.

(51) Int. Cl. C08G 63/91

(52) U.S. Cl. CPC C08G 63/916
USPC 524/605; 525/445

(57) ABSTRACT

A thermosetting composition comprises in combination an ethylenically unsaturated polymer, and a lactone reactive diluent of the formula

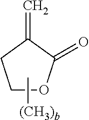

wherein b=0 or 1. A method of manufacture of a thermoset polymer comprises reacting the unsaturated polymer and the lactone to form the thermoset polymer. The thermoset polymers are described, as well as articles comprising the thermoset polymers.

### CROSS REFERENCED TO RELATED APPLICATION

This application claims the benefit of provisional application of U.S. Patent Application No. 61/618,559 filed on Mar. 30, 2012, which is incorporated by reference herein in its entirety.

### FIELD OF THE INVENTION

This disclosure relates generally to reactive diluents for unsaturated polymers, in particular to lactone reactive diluents, methods of reacting, and thermoset polymers made therewith.

### BACKGROUND

One method of altering polymer properties is by post-polymerization modification of the polymer, for example crosslinking. Such modification can be accomplished by reaction of the polymer with a reactive diluent, i.e., a crosslinker or other co-monomer that forms a link between two reactive sites. The reactive sites can be within the same polymer chain or in two different polymer chains.

For example, polymers can be directly crosslinked by irradiation of unsaturated groups in the polymer. Irradiation crosslinking can have limitations, for example cost, scale-up problems, or side reactions. In addition, irradiation is affected by, or could interfere with various additives such as dyes, pigments, or antioxidants. Chemical reaction between two reactive sites of one or more polymer chains has also been used, either directly or via a crosslinking agent such as styrene or methyl methacrylate in the presence of a catalyst and optional accelerator. However, these crosslinking agents have the disadvantages of toxicity and of being derived from fossil-based feedstocks. Depending on the crosslinking agent, the resulting crosslinked polymers can have poor thermal or ultraviolet (UV) stability.

### SUMMARY

In an embodiment, a thermosetting composition comprises in combination an ethylenically unsaturated polymer, and a lactone reactive diluent of the formula

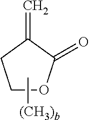

wherein b=0 or 1.

In another embodiment, a method of manufacture of a thermoset polymer comprises reacting the unsaturated polymer and the lactone reactive diluent to form the thermoset polymer.

In still another embodiment, a method of manufacture of an article comprises shaping the above-described thermosetting composition, and reacting the unsaturated polymer and the lactone reactive diluent to form the article.

Also disclosed is a thermoset polymer comprising a lactone unit of the formula

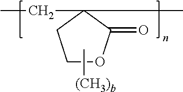

wherein b is 0 or 1, and wherein n is 1 to 500,000.

In another embodiment, an article comprising the thermoset polymer is described.

These and other features and advantages are further described in the following Detailed Description, Examples, and Claims.

### DETAILED DESCRIPTION

Despite the wide variety of reactive diluents available in the art, there remains a need for new reactive diluents. For example, there remains a need for reactive diluents that can be derived from renewable, rather than petrochemical, sources. It would be a further advantage if such reactive diluents were of low toxicity, for example lower toxicity than reactive diluents such as styrene or methyl methacrylate. It would be a still further advantage if the resulting “thermoset polymers” had one or more of improved thermal stability, UV stability, and solvent resistance.

The inventors hereof have found that unsaturated polymers can be readily reacted with an ethylenically unsaturated lactone having the structure (1)

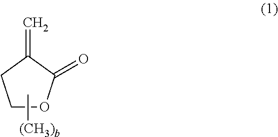

wherein b=1 or 0. For convenience, the ethylenically unsaturated lactone (1) can be referred to herein as a reactive diluent or a lactone reactive diluent. Reactive diluents are often referred to as crosslinkers or crosslinking agents in the art, and in an embodiment the ethylenically unsaturated lactones (I) function as a crosslinking agent, although other modes of reaction are also contemplated. In an especially advantageous feature, the lactone reactive diluent can be derived from biological feedstocks, reducing the strain on petroleum-based feedstocks. The resultant polymer can have one or more of improved thermal stability, improved UV stability, and improved solvent resistance.

A wide variety of polymers can be thermoset with lactones (1), provided that the polymers are reactive with the lactones, and in particular with the ethylenically unsaturated group on the lactone. Such reactivity can be provided by ethylenic unsaturation in the polymer. The ethylenic unsaturation can be in the backbone of the polymer either within the backbone or at a terminal end thereof, pendant from the backbone of the polymer, either alone or as a part of another pendant group, or a combination thereof. “Polymers” as used herein includes compounds having an average of two or more, three or more, four or more, or five or more units, and thus includes oligomers. In an embodiment the unsaturated polymer has an average of two or more ethylenic unsaturations per polymer chain, three or more, four or more, or five or more ethylenic unsaturations per polymer chain.

Examples of polymers containing ethylenic unsaturation include diene polymers such as polychloroprene, polydicyclopentadiene, polyisoprene, and polybutadiene, as well as copolymers of dienes with other comonomers (such as isoprene, vinyl alcohol, vinyl ethers, vinyl halides, (meth)acrylates, (meth)acrylic acids, monoalkenyl aromatic hydrocarbons such as styrene, and the like), for example poly(styrene-butadiene-styrene) (SBS), styrene-ethylene-butadiene-styrene (SEBS), and methacrylate-butadiene-styrene (MBS).

In addition to the foregoing polymers, a number of polymers can be manufactured to contain ethylenic unsaturation by including appropriately functionalized monomers in the polymerization, or by post-polymerization modification. For example, silicone polymers can be manufactured to contain unsaturated groups by inclusion of monomers containing unsaturated groups. Reaction of a carboxyl or other reactive terminal group of a polymer with allyl alcohol, for example, can be used to provide a polymer with terminal unsaturation. Examples of the types of polymers that can be modified to contain unsaturation by copolymerization or by post-polymerization modification include polyacrylonitriles, polyamides, poly(arylene oxides), polysulfides (including poly(arylene sulfides)), polycarbonates, polycyanoacrylates, polyesters including alkyds, polyether sulfones, polyethylenes (including polytetrafluoroethylene)s, polyimides (including polyetherimides), polyketones, poly(meth)acrylates, polypropylenes, polystyrenes, polyurethanes, poly(vinyl acetate)s, poly(vinyl alcohol)s, poly(vinyl ether)s, poly(vinyl halide)s, epoxies, and silicones.

Polyesters, for example, can be readily produced to contain ethylenic unsaturation, and can be any polyester that comprises an unsaturation that can be reacted with lactone (1). The particular unsaturated polyester is selected based on the desired properties of the polyester, including those desired for its intended use, whether a formulation or an article.

As is known, polyesters can also contain units derived from the acyclic diene metathesis (ADMET) polymerization of a cyclic unsaturated anhydride and a diol or the condensation of a dicarboxylic acid (or reactive derivative thereof) and a diol (or reactive derivative thereof). Use of a dicarboxylic acid and/or diol having at least one ethylenically unsaturated group provides a polyester with ethylenically unsaturated groups. In an embodiment, the unsaturated polyester is derived from a dicarboxylic acid component that comprises an ethylenically unsaturated dicarboxylic acid (or reactive derivative thereof) and a saturated, unsaturated, or aromatic diol (or reactive derivative thereof). In another embodiment, the unsaturated polyester is derived from a diol component comprising an ethylenically unsaturated group (or reactive derivative thereof) and a saturated, unsaturated, or aromatic dicarboxylic acid.

The ethylenically unsaturated dicarboxylic acid can be any that is sufficiently reactive to form the polyester. Examples of ethylenically unsaturated dicarboxylic acids that can be used include maleic, fumaric, substituted fumaric, citraconic, mesaconic, teraconic, glutaconic, muconic, chloromaleic, itaconic, and “dimer” acid (i.e., dimerized fatty acids). A combination of different ethylenically unsaturated dicarboxylic acids can be used. In an embodiment, the ethylenically unsaturated reactive dicarboxylic acid derivative is maleic anhydride.

Examples of saturated and aromatic carboxylic acids that can be used in combination with an ethylenically unsaturated dicarboxylic acid or ethylenically unsaturated diol include oxalic, malonic, succinic, gluconic, glutaric, and sebacic, adipic, phthalic, o-phthalic, isophthalic, terephthalic, substituted phthalic, pimelic, tartaric, cyclopropanedicarboxylic, cylohexanedicarboxylic, tetrachlorophthalic tetrahydrophthalic, suberic, and azelaic. Of course, tricarboxylic and higher acids can be present to provide branching or crosslinking, for example citric, isocitric, aconitic, tricarballylic, trimellitic acid, and pyromellitic acid.

The ethylenically unsaturated diol can be any that is sufficiently reactive to form the polyester. Examples of ethylenically unsaturated diols that can be used include 1,4-butene diols (e.g., 2-buten-1,4-diol), 1,4-butyne diols (e.g, 2-butyn-1,4-diol), hexene diols (e.g. 3-hexen-2,5-diol and 3-hexen-1,6-diol) octenediols, (e.g., 4-octen-1,8-diol) and cyclohexene diols (e.g., 2-cyclohexen-1,4-diol, 3-cyclohexen-1,2-diol, and 4-cyclohexen-12-diol). Seed oils and other oils from renewable sources can be used, for example castor oil, soy oil, canola oil, jatropha oil, sesame oil, olive oil, sunflower seed oil, grape seed oil, linseed oil, vegetable oil, peanut oil, coconut oil, coriander oil, corn oil, cottonseed oil, hempseed oil, mango kernel oil, meadowfoam oil, palm oil, palm kernel oil, rapeseed oil, rice bran oil, safflower oil, sasanqua oil, tall oil, tsubaki oil, and nut oils such as hazelnut, walnut, brazil, cashew, macadamia, kukui, and pecan oils. Polymeric diols containing two or more repeating units and two terminal hydroxy groups can be used, for example polyester diols (e.g., poly(epsilon-caprolactone) (PCL) diols, poly(epsilon-caprolactone-co-lactide) (PCLA) diols, poly(3-hydroxybutyrate) (PHB) diols, poly(diethylene glycol adipate) (PDEGA) diols, and poly(lactide) (PLA) diols), polyether diols (e.g, poly(ethylene glycol), poly(propylene glycol), and poly(tetramethylene glycol)), and polycarbonate diols (e.g, a poly(bisphenol A carbonate) diol). A combination comprising at least one of any of the foregoing ethylenically unsaturated diols can be used.

Examples of saturated and aromatic diols that can be used in combination with an ethylenically unsaturated dicarboxylic acid or ethylenically unsaturated diol include ethylene glycol, diethylene glycol, triethylene glycol, tetraethylene glycol, propylene glycol (e.g. 1,2-propylene glycol and 1,3-propylene glycol), butylene glycol (e.g., 1,2-butanediol, 1,3-butanediol, and 1,4-butanediol), cyclobutanediol, pentanediol (e.g., 1,2-pentanediol, 1,4-pentanediol, 1,5-pentanediol, 2,2-dimethyl-1,3-propanediol, 2-methyl-1,3-propanediol, 2-butyl-2-ethyl-1,3-propanediol, and 2,2,4-trimethyl-1,3-pentanediol), hexanediol, e.g., 1,6-hexanediol), cyclohexanediol, cyclohexanedimethanol, dipropylene glycol, tripropylene glycol, isopropylidene bis-(p-phenyleneoxypropanol-2), glycol, neopentyl glycol, resorcinol, hydroxypivalyl hydroxypivalate, polyethylene glycol or derivatives thereof, polypropylene glycol or derivatives thereof, polyethylene oxides, polypropylene oxides, trimethylol propane polymers having an overall hydroxy functionality of 2-4 per molecule and a molecular weight of 300-12,000 g/mole, and Bisphenol A. Monovalent or trivalent (or higher) alcohols can be used in combination with the diols, where examples of such include octyl alcohol, oleyl alcohol, trimethylolpropane, glycerol, trimethylol ethane, pentaerythritol, and sorbitol. Polyols containing more than two hydroxyl are generally employed in minor proportions relative to the diol or diols used.

When the dicarboxylic acid component provides the ethylenic unsaturation, the ethylenically unsaturated dicarboxylic acid can be used in combination with a saturated or aromatic dicarboxylic acid, i.e., one that does not contain a reactive ethylenic unsaturation. In embodiments where such saturated or aromatic dicarboxylic acids are used, the amount thereof can be 1 to 99%, 5 to 95%, 10 to 90%, or 20 to 80% of the total equivalents of carboxyl groups in the esterification mixture, more specifically 30 to 70%, or 40 to 60% of the total equivalents of carboxyl groups in the esterification mixture. When the diol component provides the ethylenic unsaturation, the ethylenically unsaturated diol can be used in combination with a saturated or aromatic dicarboxylic acid, i.e., one that does not contain a reactive ethylenic unsaturation. In embodiments where such saturated or aromatic diols are used, the amount thereof can be 1 to 99%, 5 to 95%, 10 to 90%, or 20 to 80% of the total equivalents of diol groups in the esterification mixture, more specifically 30 to 70%, or 40 to 60% of the total equivalents of diol groups in the esterification mixture.

In addition, or alternatively, the polyesters can comprise a different terminal moiety containing an ethylenically unsaturated group. Such groups can be incorporated during polymerization (i.e., as an endcapping agent) or by post-polymerization modification. For example, the unsaturated polyester can comprise a terminal group derived from dicyclopentadiene (DCPD). Methods for the manufacture of these and other unsaturated polyesters are known. For example, monomers can be added in a single stage or in a multi-stage synthesis. Multi-stage synthesis can be used when one or more of the monomers have a poor solubility in the monomer mixture and low reactivity. In such multi-stage designs, a prepolymer is formed with the monomer with the lower reactivity before addition of monomer with the faster reactivity to prevent the early, complete incorporation of the monomer with the higher reactivity. A general description of unsaturated polyesters and methods for their manufacture can be found in “Preparation, Properties, and Applications of Unsaturated Polyesters” by K. G. Johnson & L. S. Yang in Modern Polyesters. Chemistry and Technology of Polyesters and Copolyesters, edited by John Scheirs and Timothy E. Long, John Wiley, 2003.

Unsaturated polyesters can also be formed by the ring opening, for example ring opening polymerization (ROP) or ring opening metathesis polymerization (ROMP) of certain cyclic unsaturated esters, for example unsaturated epsilon-lactones, lactams, and cyclic anhydrides such as exo-7-oxabicyclo[2.2.1]hept-5-ene-2,3-dicarboxylate anhydride (the Diels-alder reaction product of maleic anhydride and furan).

In a specific embodiment, the polyester is derived from a dicarboxylic acid component comprising maleic, fumaric, isophthalic, and phthalic (or a reactive derivative thereof) and ethylene glycol, diethylene glycol, n-propylene diol, di-n-propylene diol, 1,4-butanediol (or a reactive derivative thereof).

As stated above, the type of unsaturated polyester and its properties are selected based on manufacturing conditions, availability, intended use, cost, and like considerations. Thus, the polyesters can be linear or branched. The molecular weight of the unsaturated polyester can vary over a wide range, for example from 500 to 200,000 g/mole, or 1,000 to 100,000 g/mole. The acid number can be 1 to 100, or 2 to 50, or less than 35.

Another example of an unsaturated polymer that can be used is an epoxy vinyl ester polymer that contains two or more ester groups, each containing at least one ethylenic unsaturation. (The term epoxy “vinyl” ester is used for convenience, and encompasses vinyl, allyl, and fully substituted ethylenically unsaturated groups.) In general, epoxy vinyl ester polymers can be prepared by (1) reacting a polyepoxide with an ethylenically unsaturated carboxylic acid to produce a reaction product that contains, in part, the functional group —C(═O)—O—CH₂—CH(OH)—, for example produced by the ring-opening reaction of an epoxide group with a carboxylic acid group. In some embodiments the secondary hydroxyl groups are further condensed with a dicarboxylic acid anhydride to produce pendant half ester groups.

Ethylenically unsaturated carboxylic acids that can be used in the reaction with the polyepoxide include unsaturated monocarboxylic acids and the hydroxyalkyl acrylate or methacrylate half esters of dicarboxylic acids. Examples of unsaturated monocarboxylic acids include acrylic acid, methacrylic acid, crotonic acid, and cinnamic acid. The hydroxyalkyl group of the acrylate or methacrylate half esters can contain from two to six carbon atoms and can be, for example, hydroxyethyl, beta-hydroxy-propyl, or beta-hydroxybutyl. The hydroxyalkyl group can also include an ether oxygen. The dicarboxylic acids can be either saturated or unsaturated. Saturated acids include phthalic acid, chlorendic acid, tetrabromophthalic acid, adipic acid, succinic acid, and glutaric acid. Unsaturated dicarboxylic acids include maleic acid, fumaric acid, citraconic acids, itaconic acid, halogenated maleic or fumaric acids, and mesaconic acid. A mixture of saturated and ethylenically unsaturated dicarboxylic acids can be used.

The half esters can be prepared by reacting substantially equal molar proportions of a hydroxyalkyl acrylate or methacrylate with a dicarboxylic acid anhydride. Other unsaturated anhydrides include maleic anhydride, citraconic anhydride and itaconic anhydride. Saturated anhydrides include phthalic anhydride, tetrabromophthalic anhydride, and chlorendic anhydride. A polymerization inhibitor, such as hydroquinone or the methyl ether of hydroquinone can be used in preparing the half esters.

Any known polyepoxide can be used in the preparation of the epoxy vinyl ester resins. Examples of polyepoxides include glycidyl polyethers of polyhydric alcohols, polyhydric phenols, epoxy novolacs, elastomer modified epoxide, halogenated epoxides, epoxidized fatty acids or drying oil acids, Bisphenol A epoxies, epoxidized diolefins, epoxidized di-unsaturated acid ester, epoxidized unsaturated polyesters and mixtures thereof, as long as they contain more than one epoxide group per molecule.

Examples of dicarboxylic acid anhydrides for reaction with the secondary hydroxyl groups include both the saturated anhydrides, such as phthalic anhydride, tetra-bromo-phthalic anhydride, and chlorendic anhydride, and the unsaturated dicarboxylic acid anhydrides, such as maleic anhydride, citraconic anhydride, and itaconic anhydride.

In an embodiment, the epoxy resin can be endcapped with methacrylic acid to impart terminal ethylenic unsaturations. In an embodiment the epoxy vinyl ester comprises a Novolak functionality and can comprise three or more unsaturated groups. The epoxy vinyl ester can be a brominated epoxy vinyl ester and can have improved flame retardant properties. In another embodiment the epoxy vinyl ester comprises repeat units derived from bisphenol A.

The unsaturated polymers, in particular the unsaturated polyesters or epoxy vinyl esters, are reacted with the lactone reactive diluent (1) to provide a thermoset polymer, that is, a polymer comprising crosslinks, i.e., a chemical bond between the unsaturated carbon atoms of the lactone and the unsaturated carbon atoms of the polymer. In an embodiment, the lactone reactive diluent is α-methylene-γ-valerolactone (4,5-dihydro-5-methyl-3-methylene-2(3H)-furanone) (1a)

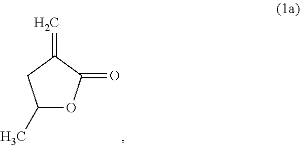

α-methylene-γ-butyrolactone (3-methylene-dihydro-2(3H)furanone) (1b)

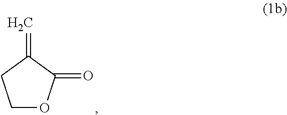

or a combination of comprising at least one of the foregoing reactive diluents.

Other reactive diluents, including other crosslinkers, can optionally be used in combination with the lactone (1), specifically (1a) or (1b). Such additional reactive diluents include compounds having at least one ethylenically unsaturated groups, for example vinyl groups, allyl groups, or (meth)acrylate groups in the molecule. Examples of reactive diluents having one ethylenic double bond include monoalkenyl aromatic hydrocarbons such as styrene, p-chlorostyrene, and alpha-methyl styrene; an ester of (meth)acrylic acid with an alcohol having 1 to 18 carbon atoms (e.g., methyl (meth)acrylate, and butyl (meth)acrylate), and an ester of a dicarboxylic acid such maleic acid, fumaric acid, and itaconic acid with an alcohol having 1 to 18 carbon atoms (e.g., dimethyl maleate).

Where desired, in addition to the ethylenically unsaturated group, the optional additional reactive diluent can include another functional groups such as hydroxy group. Examples of additional reactive diluents of this type include hydroxy (meth)acrylates such as 2-hydroxyethyl (meth)acrylate, 2-hydroxypropyl (meth)acrylate, and 2-hydroxybutyl (meth)acrylate, an alkyl(hydroxyalkyl) ester of maleic acid such as methyl(2-hydroxyethyl) maleate, ethyl(2-hydroxyethyl) maleate, propyl(2-hydroxyethyl) maleate, butyl(2-hydroxyethyl) maleate, methyl(2-hydroxypropyl) maleate, and ethyl(2-hydroxybutyl) maleate, an alkyl(2-hydroxyalkyl) ester of itaconic acid such as methyl(2-hydroxyethyl) itaconate, ethyl(2-hydroxyethyl) itaconate, propyl(2-hydroxyethyl) itaconate, ethyl(2-hydroxypropyl) itaconate, and methyl(2-hydroxybutyl) itaconate, an alcohol having an allyl group such as allyl alcohol, an amide such as hydroxymethylacrylamide and hydroxymethylmethacrylamide, and a hydroxyalkylstyrene such as hydroxymethylstyrene and hydroxyethylstyrene.

Examples of reactive diluents having two or more ethylenic unsaturated groups in the molecule, optionally with another functional group such as a hydroxyl group, include N,N-methylene bisacrylamide, N,N′-methylenebismethacrylamide, 1,2-, 1,3-, and 1,4-butanediol di(meth)acrylate, ethyleneglycol di(meth)acrylate, propylene glycol di(meth)acrylate, diethyleneglycol di(meth)acrylate, triethyleneglycol di(meth)acrylate, polyethyleneoxide glycol di(meth)acrylate, dipropyleneglycol di(meth)acrylate, triethyleneglycol di(meth)acrylate, glycerol di(meth)acrylate, glycerol tri(meth)acrylate, 1,2- and 1,3-propanediol di(meth)acrylate, 1,2-, 1,3-, 1,4-, 1,5- and 1,6-hexanediol di(meth)acrylate, 1,2- and 1,3-cyclohexanediol di(meth)acrylate, pentaerythritol di(meth)acrylate, pentaerythritol tri(meth)acrylate, pentaerythritol tetra(meth)acrylate, trimethylolpropane tri(meth)acrylate, ethoxylated trimethylolpropane tri(meth)acrylate, tris (2-hydroxyethyl) isocyanurate tri(meth)acrylate, triallyl isocyanurate, allyl(meth)acrylate, pentaerythritol diallyl ether, pentaerythritol triallyl ether, pentaerythritol tetraallyl ether, diallyl ether, tetrallyloxyethane, tetrallyloxypropane, tetrallyloxybutane, divinylbenzene, divinyltoluene, diallyl phthalate, divinyl xylene, trivinyl benzene, and divinyl ether.

Different methods can be used for the reaction of the reactive diluent with the unsaturated polymer to form a thermoset polymer. In an embodiment, the thermoset polymers are formed by contacting the unsaturated polymer, specifically a polyester or epoxy vinyl ester, the lactone reactive diluent (1), specifically (1a) or (1b) (and optional other reactive diluents), in the presence of a free radical initiator and an optional accelerator and other additives at a temperature and for a length of time sufficient to react the unsaturated polymer and the lactone reactive diluent. The temperature, pressure, and time of contact will depend on the type and amount of components present, the type of initiator used, addition rate of the reactants, compatibilizing agents (if present), solubilities of the monomer, unsaturated polymer, and thermoset polymer, and like considerations, as well as the degree of desired reaction. For example, in some embodiments reactants and reaction conditions are selected to achieve substantially complete reaction of the unsaturation in the starting polymer, which can produce a thermoset polymer. In other embodiments, the differential solubilities of the lactone, other reactive diluents, and thermoset polymer can be such that a gel is produced. Adjusting reaction temperature, rate of reactive diluent addition, amount of diluent added, or other reaction parameters can be used to adjust the desired degree of reaction.

The initiator can be a thermal initiator, i.e., activated by heat. Examples of thermally activated initiators include peroxides such as dicumyl peroxide, t-butyl perbenzoate, t-butyl hydroperoxide, succinic acid peroxide, cumene hydroperoxide, acyl peroxide, ketone peroxide, dialkyl peroxide, hydroperoxide, methyl ethyl ketone peroxide, benzoyl peroxide, and the like, azo compounds such as azobis-butyronitrile, and the like. The thermal initiators can be present in an amount of 1 part per million (ppm) by weight, to 20 wt. % of the total weight of the thermosetting composition.

Accelerators are compounds that facilitate development of radicals under the effect of the aforementioned catalysts. Examples of accelerators that can be used include cobalt organic acid salts, vanadium organic acid salts, manganese organic acid salts, and tertiary amino compounds. When used, accelerators are present in an amount of, for example, 0.1 to 2.0 wt. %, based on the weight of the unsaturated polymer. Likewise, retardants, for example 2,4-pentanedione, can be used to adjust the rate of reaction.

Photoinitiators can be used, such as visible or UV light-activated photoinitiators, including hydroxycyclohexylphenyl ketones; other ketones such as alpha-amino ketone and 4-(2-hydroxyethoxy)phenyl-(2-hydroxy-2-propyl)ketone; 2-hydroxy-2-methyl-1-phenyl-propan-1-one; 2-isopropyl-9H-thioxanthen-9-one; benzoins; benzoin alkyl ethers; benzophenones, such as 2,4,6-trimethylbenzophenone and 4-methylbenzophenone; trimethylbenzoylphenylphosphine such as 2,4,6-trimethylbenzoyl-diphenyl-phosphine oxide or phenylbis(2,4,6-trimethylbenzoyl)phosphine oxide; azo compounds such as AIBN; anthraquinones and substituted anthraquinones, such as alkyl-substituted or halo-substituted anthraquinones; other substituted or unsubstituted polynuclear quinines; acetophenones, thioxanthones; ketals; and acylphosphines. In an embodiment, the photoinitiator is a hydroxycyclohexylphenyl ketone, such as 2-hydroxy-4′-hydroxyethoxy-2-methylpropiophenone or 1-hydroxycyclohexylphenyl ketone, ethyl-2,4,6-trimethylbenzoylphenylphosphinate, a mixture of 2,4,6-trimethylbenzophenone and 4-methylbenzophenone; a mixture of 2,4,6-trimethylbenzoyl-diphenyl-phosphine oxide and 2-hydroxy-2-methyl-1-phenyl-propan-1-one; 4-(2-hydroxyethoxy)phenyl-(2-hydroxy-2-propyl) ketone; and 2-isopropyl-9H-thioxanthen-9-one. The photoinitiator can be used in amounts of 0.5 to 15 wt. %, more specifically from 3 to 12 wt. %, based on the total weight of the thermosetting composition. Photoinitiators are often used in the manufacture of layers, i.e., films or sheets.

An accelerator can also be used in conjunction with the photoinitiator. The accelerator can be chosen which absorbs radiation in one part of the visible or ultra-violet region (for example 2,000 to 3,000 A) and emits in another part of the visible or ultra-violet region, for example, near or long wave length ultra-violet (3,000 to 4,000 A). Exemplary accelerators include dimethylaniline, diethylaniline, 2-aminopyridine, N,N-dimethyl acetoacetamide, acetoacetanilide, ethyl acetoacetate, methyl acetoacetate, N,N-dimethyl-p-toluidine, N,N-dimethyl-o-toluidine, beta-naphthylamine, sulfosalicyclic acid, N-chlorophthalimide, and resorcinol monobenzoate. Other accelerators include organic tertiary amines, for example (meth)acrylate derivatives such as dimethylaminoethyl methacrylate, diethylaminoethyl methacrylate (DEAEMA), and the like, or tertiary aromatic amines such as 2-[4-(dimethylamino)phenyl]ethanol (EDAB), N,N-dimethyl-p-toluidine (commonly abbreviated DMPT), bis(hydroxyethyl)-p-toluidine, triethanolamine, and the like. Such accelerators are generally present at about 0.1 to about 4.0 wt. % of the polymer component.

A co-promoter can be used. Exemplary co-promoters include acetoacetoxy ethyl (meth)acrylate, and C₁₋₈ linear or branched alkyl acetoacetates. The co-promoter can be present in an amount of less than or equal to 10 wt. % of the polymer component.

A combination of a thermal initiator and a photoinitiator can be used. When a thermal initiator is used, useful temperatures are those effective to initiate reaction between the polymer and the lactone (I), e.g., crosslinking, but not so high as to result in significant degradation of the polymer or other components. Reacting can be performed, for example, at 25 to 200° C. for 1 to 20 hours, specifically 50 to 100° C. for 5 to 20 hours. When a photoinitiator is used, cure can be accomplished at ambient temperature or elevated temperature.

Alternatively, reacting can be performed by irradiating ionizing radiation. Examples of the ionizing radiation that can be used include γ-ray, X-ray, β-ray, and α-ray. In an embodiment γ-ray irradiation with cobalt-60 or electron beam irradiation by an electron beam accelerator is used. The irradiation of ionizing radiation can be performed under an inert atmosphere or under vacuum as the active species produced upon irradiation with ionizing radiation can couple with oxygen in air and deactivate. The irradiation dose of ionizing radiation can be from 10 to 200 kGy, from 50 to 150 kGy, more specifically from 80 to 120 kGy. The radiation can be continuous or pulsed. High energy radiation can also be used in combination with a peroxide catalyst.

After reacting, the polymers contain lactone units of formula (2)

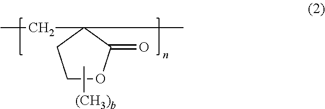

wherein b is 0 or 1, and n is 1 to 500,000, specifically of formula (2a) or (2b)

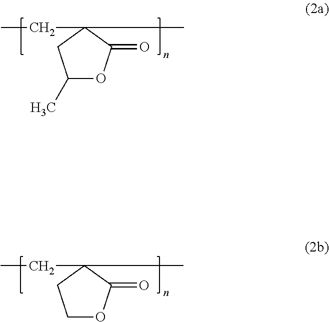

wherein n is 1 to 500,000. In any of units (2), (2a), or (2b), n can be 1 to 400,000, 1 to 300,000, 1 to 200,000, 1 to 100,000, 1 to 50,000, 1 to 30,000, 1 to 20,000, 1 to 10,000, 1 to 5,000, 1 to 1,000, 1 to 500, or 1 to 250. In another embodiment n is 1 to 200, 1 to 150, 1 to 100, 1 to 50, 1 to 30, 1 to 20, 1 to 15, 1 to 10, or 1 to 5. A value of 1 to 10 can be specifically mentioned. The amount of lactone units (2), specifically (2a) or (2b), can be 10 to 80 wt. %, 20 to 70 wt. %, 30 to 70 wt. %, 40 to 60 wt. %, or 45 to 55 wt. % based on the weight of the polymer. In another embodiment, for example in gel coats, the amount of lactone units (2), (specifically (2a) or (2b), is 50 to 90 wt. %, 55 to 80 wt. %, 60 to 80 wt. %, or 65 to 75 wt. %, based on the weight of the polymer. In an embodiment, the amount of lactone units (2), specifically (2a) or (2b) can is greater than 30 wt. % based on the weight of the polymer. However, in another embodiment, the amount of lactone units (2), (2a), or (2b) is less than 30 wt. %, less than 20 wt. %, or less than 15 wt. % based on the weight of the polymer.

The value of n, and the properties of the thermoset polymers as stated above, can be adjusted by adjusting the reaction conditions (the temperature, pressure, and time of contact) as well as the type and amount of components present in the reaction, the type of initiator used, addition rate of the reactants, compatibilizing agents (if present), solubilities of the monomer, unsaturated polymer, and thermoset polymer, and like considerations. For example, the molecular weight of the lactone residues between crosslinks can be varied by varying the amount of lactone relative the amount of unsaturation in the polymer, wherein a large excess of lactone relative to unsaturation (on a mole basis) will tend to increase the molecular weight of the lactone segments. Alternatively, the molecular weight of the polymer segments between crosslinks can be adjusted by varying the amount of unsaturation in the polymer and the molecular weight of the unsaturated. In another example, a method to vary the properties of the thermoset polymer is to vary the number of unsaturations in the polymer, and the degree of reaction. When the number of ethylenic unsaturations per polymer chain is, for example, 2 or greater, and the reaction is substantially complete, for example 90% or more of the unsaturated groups have reacted, the thermoset polymer will be a fully or nearly fully crosslinked polymer. Such thermoset polymers can have improved mechanical properties. On the other hand, when the number of ethylenic unsaturations per polymer chains is low, for example less than 2, the thermoset polymer can be sol-gel material.

The glass transition temperature of the thermoset polymer, specifically a thermoset or crosslinked polyester, can vary widely, depending on the starting polymer and extent of reaction. In an embodiment, the Tg of the thermoset polymer is 30° C. to 250° C. In another embodiment the Tg of the thermoset polymer, for example the thermoset polyester, is greater than 30° C., 40° C., 50° C., 60° C., 70° C., 80° C., 90° C., or 100° C., up to 250° C. It has been found that a greater increase in Tg can be achieved using a smaller amount of lactone reactive diluent, compared to a reactive diluent such as styrene. Thus, a thermoset polymer comprising lactone units can have a higher Tg than the same polymer thermoset with the same amount of another reactive diluent, such as styrene. In some embodiments, even where higher amount of a reactive diluent such as styrene are used, the same Tg can be achieved with lower amounts of lactone reactive diluent.

The thermoset polymers can further have excellent heat distortion temperatures (HDT) as measured by ASTM D648 (2010). For example, the thermoset polymers can have an HDT of 50° C. or higher, 100° C. or higher, or 150° C. or higher, as measured by ASTM D648 (2010) using a load of 1.8 MPa. As described above for Tg, higher HDT values can be obtained using relatively lower amounts of the lactone reactive diluents compared to other reactive diluents such as styrene.

The thermoset polymer can be transparent or opaque depending upon polymer or polymers thermoset and other conditions as described above. For example, a transparent polymer can be obtained by adjusting the parameters of the reaction (e.g., temperature, concentration, and compatibilizer) to maximize solubility of the components during the reaction. In an embodiment, the thermoset polymers can have a luminous transmittance of more 75% or higher, 85% or higher, or 90% or higher, and a haze of 25% or lower, 15% or lower, or 3% or lower.

Use of the lactone reactive diluents can provide further advantages relative to other reactive diluents, especially aromatic reactive diluents, for example improved ultraviolet light stability.

In use, a thermosetting composition is formed comprising the unsaturated polymer, the lactone reactive diluent (1), specifically (1a) or (1b), and any other components (initiator, accelerator, and any other additives). The thermosetting composition is shaped and the unsaturated polymer is reacted to provide a thermoset polymer. It is to be understood that in some embodiments, depending on the polymer used and the degree of reacting, the thermoset polymers can be thermoformable. In other embodiments, the thermosetting composition is shaped and partially reacted (“B-staged”). The B-staged article can then be, stored, shipped, and subsequently fully reacted, with or without further shaping.

Various other polymers or additives can be incorporated into the thermosetting compositions comprising the unsaturated polymer and the lactone reactive diluent, and are selected depending on the end use of the thermoset polymer. Examples of other polymers include polyamides, poly(arylene ether)s, poly(arylene sulfide)s, polycarbonates, polyesters, polyimides such as polyetherimides, polyolefins, polyvinyl chloride, poly(alkyl) (meth)acrylates, epoxies, polystyrene, poly (vinyl acetate), polyurethanes, and silicones. Examples of saturated polyesters that can be present include polyglycolide, polylactic acid (PLA), polycaprolactone, polyethylene adipate, polyhydroxyalkanoate, polyethylene terephthalate, polybutylene terephthalate, polytrimethylene terephthalate, polybutylene succinate, and polyethylene naphthalate. In an embodiment no other polymers are present.

Examples of additives include a particulate filler (e.g., silica, talc, calcium carbonate, clays, or calcium silicate), a fibrous reinforcement (e.g. glass fibers), an ultraviolet (UV) absorber, a UV stabilizer, a heat stabilizer, an antioxidant, a dye, a colorant, a pigment, a pigment extender, a color stabilizer, a mold release agent (e.g. zinc stearate and calcium stearate), air release agent, a low profile additive, a plasticizer, an antistatic agent, a flame retardant, an anti-drip agent, a coupling agent, a thixotropic agent, an anti-foaming additive, an anti-settling agent, an adhesion promoter, an X-ray contrast agent, an organic wax, a metal salt, a surfactant, a metal promoter (e.g. cobalt, manganese, iron, vanadium, and copper) and a wetting agent. Such additives can at any suitable time during combination of the components for forming the thermosetting composition. Except for other polymers and fillers, the additives are generally present in a total amount of 0.0005 to 20 wt. %, specifically 0.01 to 10 wt. % based on the total weight of the thermosetting composition, excluding any particulate filler or fibrous reinforcement.

Particulate fillers that can be used include inorganic and organic fillers such as titanium dioxide (rutile and anatase), barium titanate, strontium titanate, silica, including fused amorphous silica, corundum, wollastonite, aramide fibers (e.g., KEVLAR™ from DuPont), fiberglass, Ba₂Ti₉O₂₀, glass particles, glass spheres, quartz, boron nitride, aluminum nitride, silicon carbide, beryllia, alumina, magnesia, magnesium hydroxide, mica, talcs, nanoclays, aluminum trihydroxide, ammonium polyphosphate, boehmite aluminum phosphinate, potassium titanate, aluminum borate, aluminosilicates (natural and synthetic), and fumed silicon dioxide (e.g., Cab-O-Sil, available from Cabot Corporation), used alone or in combination. The fillers can be in the form of solid, porous, or hollow particles. The particulate filler can be in any configuration including spheres, whiskers, fibers, particles, plates, acicular, flakes, or irregular shapes. The average particle size of the particulate filler can 1 nm to 1 mm, 10 nm to 100 micrometers, 20 nm to 50 micrometers, or 50 nm to 10 micrometers. To improve adhesion between the fillers and polymer, the filler can be treated with one or more coupling agents, such as silanes, zirconates, or titanates.

When the thermosetting composition comprising the unsaturated polymer and the lactone reactive diluent further comprises a fibrous reinforcement, any of the available forms can be used, such as mats of chopped or continuous strands, fabrics, including woven and nonwoven fabrics, and chopped rovings. Generally, the fibers have a length greater than 0.5 centimeters, although shorter fibers can also be used. The fibers can have an aspect ratio (length:diameter) of 1.5 to 1000. The fibrous reinforcement can be glass or other material, such as carbon, basalt, aramid, cellulose, metal, asbestos, or synthetic organic fibers such as acrylonitrile fibers, polyethylene, melamine, polyamide, or linear polyester fibers. The fibers can be monofilament or multifilament fibers and can be used alone or in combination with other fibers through, for examples, co-weaving, core/sheath, side-by-side, orange type or matrix, and fibril constructions. Suitable cowoven structures include glass fiber-carbon fiber, carbon fiber-aromatic polyimide (aramid) fiber, and aromatic polyimide fiberglass fiber. When present, the amount of reinforcing fibers in the reacting thermosetting composition can be any effective amount, for example an amount of up to 99 wt. %, 1 to 90 wt. %, 10 to 80 wt. %, 15 to 80 wt. %, or 15 to 65 wt. %, each based on the total weight of the other components of the thermosetting composition.

The glass fibers can be formed from any type of fiberizable glass composition, for example those prepared from fiberizable glass compositions commonly known as “E-glass,” “A-glass,” “C-glass,” “D-glass,” “R-glass,” “S-glass,” as well as E-glass derivatives that are fluorine-free and/or boron-free. Methods of making glass filaments therefrom are well known to those skilled in the art and a more detailed description is not necessary and can be made by processes, such as steam or air blowing, flame blowing, or mechanical pulling. Commercially produced glass fibers can have nominal filament diameters of 4.0 to 35.0 micrometers, and E-glass fibers can have a nominal filament diameter of about 9.0 to about 30.0 micrometers. Use of non-round fiber cross section is also possible.

The reinforcing fibers, in particular the glass fibers can be treated with a coating agent, for example a sizing agent. Sized glass fibers can be coated on at least a portion of their surfaces with a sizing composition selected for compatibility with the matrix material. The sizing composition facilitates wet-out and wet-through of the matrix material upon the fiber strands and can assist in attaining desired physical properties in the material. In preparing the glass fibers, a number of filaments can be formed simultaneously, treated with the coating agent, and then bundled into a strand. Alternatively, the strand itself can be first formed of filaments and then treated with a coating agent. The amount of the coating agent is generally that amount which is sufficient to bind the glass filaments into a continuous strand or provide sizing, and can range from 0.1 to 5 weight %, and more specifically from 0.1 to 2 weight % based on the weight of the glass fibers.

The components of the thermosetting composition can be combined, for example dry mixed or solution blended, at a temperature and for a time that does not substantially thermally react, e.g., crosslink the thermosetting composition. The non-thermosetting composition can then be isolated, stored, shipped, and subsequently thermally reacted, or used directly.

The compositions can be shaped by known techniques, for example molding, casting, extruding, calendaring, coating, or spraying. During or after shaping, the unsaturated polymer in the composition is B-staged or fully reacted to the desired degree to form articles. There are no particular limitations with regard to the shaping and reacting (curing or crosslinking) conditions. For example, articles can be molded with heating under pressure. In heating under pressure, the polymer, which is known as a hand lay-up or spray lay-up under normal pressure, is loaded into a mold and then heated and reacted under pressure. Alternatively, the composition can be used in an injection molding procedure utilizing transfer press equipment, followed by heating and compression. Cold pressing can also be used, particularly where a photoinitiator is present. Alternatively, the reacting compositions can be used in a continuous lamination molding process, a continuous drawing process also known as pultrusion, continuous molding by the so-called filament winding method, and the like. In these molding procedures, an intermediate molding material can be used, which is premixed from the aforementioned unsaturated polymer, lactone reactive diluent, and optional additives. Such an intermediate molding material can be in the form of sheets also known as SMC (sheet molding compound) and solid or liquid intermediate materials known as BMC (bulk molding compounds), or a premix compound. The intermediate molding material can be in the form of prepreg, which is glass cloth or mat impregnated with the composition according to the disclosure. Articles can be formed by vacuum and pressure bag techniques. In an embodiment a matched-metal mold technique is used to obtain excellent surface properties by curing and molding chemically thickened mats in a matched-metal mold. The pressure and temperature of the mold, as well as molding time, depends on the particular components comprising the composition and on other factors, for example the catalyst and the size and thickness of the mat. The pressure of the mold can range from 50 psi to 3,000 psi, the temperature can range from 40° C. to 200° C., and molding time can range from 30 seconds to 30 minutes.

Articles made from the aforementioned compositions and thermoset polymers can have a desired set of properties, for example one or more of good impact strength, brittleness, mold release properties, water repelling properties, hydrostability, anti-contamination, solvent resistance, humidity resistance, salt-water resistance, UV stability, thermal stability, transparency, and the like.

In a specific embodiment the article is in the form of a layer, which as used herein includes films (i.e., thin layers having a thickness from 1 micrometer to 1 millimeter), thicker layers (i.e., sheets having a thickness greater than 1 millimeter, for example up to 5 centimeters. Multilayer articles comprising at least one layer of the thermoset polymer are also contemplated. The additional layers can include hardcoat layers, primers, tie layers, substrates, and the like. In a specific embodiment, the layer further comprises reinforcing fibers as described above.

Articles made from the aforementioned reacting compositions and thermoset polymers can find use in any application in which a tough and mechanically stress-resistant network is desired, including those in which a filler or fibrous reinforcement is included. Depending on the properties of the thermoset polymer, the articles are useful in chemical anchoring, transportation applications, marine applications, medical applications, infrastructural applications, and construction applications, particularly as a structural part in the foregoing applications.

A wide variety of articles can be formed, for example vehicle components such as under-the-hood components, bumpers, door panels, seats, quarter panels, siding, rocker panels, trim, fenders, doors, deck lids, trunk lids, hoods, bonnets, roofs, bumpers, fascia, grilles, minor housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards, aircraft components such as bulkheads, dividers, seats, and the like, marine components such as boat hulls, surfboards, kayaks, canoes, enclosures, and housings; outboard motor housings, depth finder housings, personal water-craft, jet-skis; bathtubs, shower stalls, whirlpools, pools, spas, hot-tubs, steps, step coverings and the like, and construction components such as enclosures for electrical and telecommunication devices, outdoor furniture, roofing, masonry cladding, bridges, hybrid composite beams, insulated panels, composite frames, enamels, cultured marble and castings, patchaids, additives, sanding, sanitary, tooling, cured in place pipe (CIPP), close moldings, relining, fences, flag poles, sculpture material, stone veneer, pipes, countertops, architectural ornamentation, tanks, containers, flooring, floor gratings, doors, concrete forming pans, wind turbines, and the like.

The thermoset polymer can be an article or can be used for gel-coat applications, for example coated plastic articles, coated fiberglass articles, coated cultured marble and the like, coated synthetic or natural textiles, coated photographic film and photographic prints, coated painted articles, coated dyed articles, coated fluorescent articles, coated foam articles, and the like. The thermoset polymer can be an article or can be used electrical or electronic castings, electrical or electronic pottings, electrical or electronic encapsulations, electrical or decorative laminates, protective coatings, conformal coatings, decorative coatings, and high performance applications like printed wire boards, resins coated copper foil and IC-substrates.

The following examples are illustrative and are not intended to limit this disclosure with respect to the materials, conditions, or process parameters set forth therein.

### EXAMPLES

Components used in the formulations are shown in Table 1. Components were obtained from Aldrich and used as received.

TABLE 1

| Designation | Description | Source |
|---|---|---|
| PA | Phthalic anhydride | Alfa Aesar; 99% |
| MA | Maleic anhydride | Acros Organics; 99% |
| EG | Ethylene glycol | BDH; 99+% |
| Sty | Styrene | Acros Organics; 99% |
| MBL | α-methylene-γ-butyrolactone | Ampla Chem Inc.; 98% |
| MVL | α-methylene-γ-valerolactone | TCI; >96% |
| DCP | Dicumyl peroxide | Aldrich; 98% |
| DMSO | Dimethyl sulfoxide | Alfa Aesar; 99.9+% |
| DMF | Dimethyl formamide | Acros Organics; 99.8% |

The glass transition temperature (Tg) was determined by DSC using a heating rate of 10° C./minute.

### Example 1

### Polyester Polymerization

An unsaturated polyester (UPE) was prepared by the condensation of equimolar amounts of phthalic anhydride and maleic anhydride with 1.90 molar equivalents of ethylene glycol. The condensation polymerization was run for 6 hours at 150° C. with an overhead nitrogen purge. The resulting polymer, which was soluble in DMSO as well as DMF, exhibited a glass transition temperature near 32° C.

### Comparative Example 2 and Examples 3-7

### Crosslinking of Polyesters

After isolation of the unsaturated polyester (UPE) of example 1, the unsaturated polyester was combined with styrene, α-methylene-γ-butyrolactone, α-methylene-γ-valerolactone, or a combination thereof, according to the Table 2. Each mixture was agitated on a platform shaker for 24-72 hours to homogenize the mixture. Then, dicumyl peroxide was added to the mixture. The solutions were shaken again until the dicumyl peroxide was fully dissolved. The mixtures were then poured into aluminum pans and heated at 70° C. under vacuum for 5 hours followed by heating at 90° C. for 14 hours. Table 2 shows the thermoset formulations and the properties of the resultant thermosets.

TABLE 2

| | | Sty- | | | | | Trans- | |
|---|---|---|---|---|---|---|---|---|
| Exam- | UPE | rene | MVL | MBL | DCP | Tg | parent/ | Solubility |
| ple | (g) | (g) | (g) | (g) | (g) | (° C.) | Opaque | in DMSO |
| 2* | 2.49 | 1.70 | — | — | 0.419 | 44 | Trans- | Insoluble |
| | | | | | | | parent | |
| 3 | 2.52 | — | 1.69 | — | 0.422 | 164 | Hazy | Insoluble |
| 4 | 2.74 | — | — | 1.89 | 0.468 | 133 | Opaque | Insoluble |
| 5 | 2.97 | 0.99 | 1.04 | — | 0.490 | 66 | Trans- | Insoluble |
| | | | | | | | parent | |
| 6 | 2.31 | 0.78 | — | 0.86 | 0.375 | 157 | Hazy | Insoluble |
| 7 | 2.40 | — | 0.80 | 0.81 | 0.399 | 165 | Opaque | Insoluble |

*Comparative example

Table 2 shows that the lactone reactive diluent successfully reacts with the polyester. Table 2 also shows that substituting a portion of the styrene reactive diluent with the lactone reactive diluent results in an increase in Tg. The polyester of Comparative Example 2 was thermoset with only the styrene reactive diluent and resulted in a Tg of only 44° C. The polyester of Examples 5 and 6 that were thermoset with both the styrene reactive diluent and the lactone reactive diluent and resulted in an increase in Tg of 66° C. and 157° C., respectively. The polyester of Examples 3, 4, and 7 that were thermoset with only the lactone reactive diluent, further resulted high Tg of 164° C., 133° C., and 165° C., respectively.

### Prophetic Examples A-H

### Bisphenol-A Based Epoxy Resins

A bisphenol-A epoxy vinyl ester resin is mixed according to Table 3.

TABLE 3

| Example | Epoxy vinyl ester (g) | Styrene (g) | MVL (g) | MBL (g) |
|---|---|---|---|---|
| A | 67 | — | 33 | — |
| B | 67 | — | — | 33 |
| C | 67 | 16.5 | 16.5 | — |
| D | 67 | 16.5 | — | 16.5 |
| E | 55 | — | 45 | — |
| F | 55 | — | — | 45 |
| G | 55 | 22.5 | 22.5 | — |
| H | 55 | 22.5 | — | 22.5 |

Compositions of Examples A-D are each mixed with 1.25 parts per hundred resin (phr) methylethylketone peroxide, 0.20 phr cobalt naphthenate-6%, 0.05 phr dimethylaniline, and 0.08 phr 2,4-pentanedione. The compositions are held at 25° C. for 15 minutes and then cured in an oven for 2 hours at 120° C. Compositions of Examples E-H are each mixed with 1 phr methylethylketone peroxide, 0.05 phr cobalt naphthenate-6%, 0.06 phr 0.08 phr 2,4-pentanedione. The compositions are held at 25° C. for 15 minutes and then cured in an oven for 2 hours at 125° C.

The terminology used herein is for the purpose of describing particular embodiments only and is not intended to be limiting. As used herein, the singular forms “a,” “an,” and “the” are intended to include the plural forms as well, unless the context clearly indicates otherwise. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The endpoints of all ranges directed to the same component or property are inclusive of the endpoint and independently combinable. For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. Various combinations of elements of this disclosure are encompassed by this disclosure, e.g., combinations of elements from dependent claims that depend upon the same independent claim.

Unless otherwise defined, all terms (including technical and scientific terms) used herein have the same meaning as commonly understood by one of ordinary skill in the art to which this disclosure belongs. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. “(Meth)acrylate” and includes both acrylate and methacrylate.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosure has been described with reference to certain embodiments, it will be understood by those skilled in the art that various changes can be made and equivalents can be substituted for elements thereof without departing from the scope of the disclosure. In addition, many modifications can be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A thermosetting composition, comprising in combination
an ethylenically unsaturated polymer, and
a lactone reactive diluent of the formula 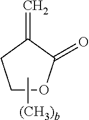
wherein b=0 or 1.

2. The thermosetting composition of claim 1, wherein the unsaturated polymer is an unsaturated polyester or an unsaturated epoxy.

3. The thermosetting composition of claim 1, wherein the lactone reactive diluent is
α-methylene-γ-valerolactone 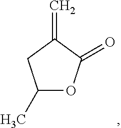
α-methylene-γ-butyrolactone 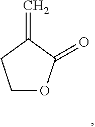
or a combination comprising at least one of the foregoing lactone reactive diluents.

4. The thermosetting composition of claim 1, further comprising an additional reactive diluent different from the lactone reactive diluent.

5. The thermosetting composition of claim 1, further comprising an initiator and an accelerator.

6. The thermosetting composition of claim 1, further comprising a particulate filler.

7. The thermosetting composition of claim 1, further comprising reinforcing fibers.

8. A method of manufacture of a thermoset polymer, the method comprising reacting the unsaturated polymer and the lactone of claim 1 to form the thermoset polymer.

9. The method of claim 8, further comprising shaping the thermosetting composition of claim 1 and reacting the unsaturated polymer and the lactone reactive diluent to form the article.

10. A thermoset polymer comprising a lactone unit of the formula 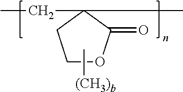
wherein b is 0 or 1, and wherein n is 1 to 500,000.

11. The thermoset polymer of claim 10, wherein the lactone unit is of the formula 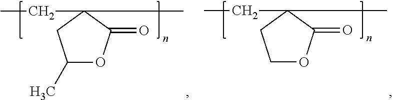
or a combination comprising at least one of the forgoing lactone units, wherein n is 1 to 500,000.

12. The thermoset polymer of claim 11, further comprising a unit derived from an additional reactive diluent different from the lactone reactive diluent.

13. The thermoset polymer of claim 11, further comprising a particulate filler.

14. The thermoset polymer of claim 11, further comprising reinforcing fibers.

15. The thermoset polymer of claim 11, wherein the polymer is a polyester or an epoxy vinyl ester.

16. The thermoset polymer of claim 11, having a Tg of 30° C. to 250° C.

17. The thermoset polymer of claim 21, wherein the thermoset polymer is transparent.

18. The thermoset polymer of claim 21, wherein the thermoset polymer is opaque.

19. An article comprising the thermoset polymer of claim 21.

20. The article of claim 19, where in the article is selected from an automotive component, an aircraft component, a construction component, and a marine component.
